(19) United States
(12) Patent Application Publication
(10) Pub. No.: US 2015/0348124 A1
(43) Pub. Date: Dec. 3, 2015

(54) Interactive Tool for Exploring Target Group

(71) Applicants: Oliver Conze, Palo Alto, CA (US); Gaith Kawar, Redwood City, CA (US); Abhijit Mitra, Palo Alto, CA (US); Prerna Makanawala, Mountain View, CA (US)

(72) Inventors: Oliver Conze, Palo Alto, CA (US); Gaith Kawar, Redwood City, CA (US); Abhijit Mitra, Palo Alto, CA (US); Prerna Makanawala, Mountain View, CA (US)

(21) Appl. No.: 14/326,227

(22) Filed: Jul. 8, 2014

Related U.S. Application Data
(60) Provisional application No. 62/006,672, filed on Jun. 2, 2014.

(51) Int. Cl. G06Q 30/02

(52) U.S. Cl. CPC G06Q 30/0269

(57) ABSTRACT

Embodiments relate to methods and apparatuses creating and analyzing target groups, for example as relied upon in conducting marketing campaigns. Certain embodiments allow predictive definition of a target group based upon an underlying complex mathematical model, which may reference large data volumes regarding individual targets in an underlying database. An interface affords simplified visualizations of the target group, for example circles of varying diameter representing target group size. Adjustable graphic elements (e.g., sliders) in dashboard views may allow predictive definition of the target group based upon inputs such as marketing cost, target group size, and/or expected revenue, etc. Once defined and stored, target groups may be explored in an interactive manner through application of filter criteria, thereby promoting familiarity with target group characteristics. Embodiments allow users who are not modeling experts, to nevertheless interact efficiently with large data volumes in order to intuitively define and/or explore a target group.

### CROSS-REFERENCE TO RELATED APPLICATION

The instant nonprovisional patent application claims priority to U.S. Provisional Patent Application No. 62/006,672 filed Jun. 2, 2014 and incorporated by reference in its entirety herein for all purposes.

### BACKGROUND

Embodiments relate to defining target groups. Particular embodiments provide methods and apparatuses providing interactive analysis for target group exploration.

Unless otherwise indicated herein, the approaches described in this section are not prior art to the claims in this application and are not admitted to be prior art by inclusion in this section.

Marketing efficiency may be improved by identifying receptive target groups. However, a large number of factors may influence the relative effectiveness of such a target group. Examples of such factors can include but are not limited to: the overall size of the target group, the budget allocated to marketing efforts directed to the target group, the expected revenue from the target group, the Return on Investment (ROI) from marketing efforts, and the various characteristics (e.g., age, gender, industry, region, etc.) comprising the members of the target group.

A target group can be modeled on the basis of available data, through the application of an underlying algorithm. However, the individuals responsible for marketing efforts have little or no knowledge of the formal structure of the model or its operation. This lack of expertise can hamper such a non-expert's ability to intuitively interact with the model to create a relevant target group in an efficient manner.

Accordingly, embodiments addresses these challenges with methods and apparatuses performing interactive analysis to efficiently explore target groups, e.g., for marketing purposes.

### SUMMARY

Embodiments relate to methods and apparatuses creating and analyzing target groups, for example as may be relied upon in conducting marketing campaigns. Certain embodiments allow predictive definition of a target group based upon an underlying complex mathematical model, which may reference large volumes of target data present in a database. An interface affords simplified visualizations of the target group, for example circles of varying diameter representing target group size. Adjustable graphic elements (e.g., sliders) in dashboard views may allow predictive definition of the target group based upon inputs such as marketing cost, target group size, and/or expected revenue, etc. Once defined and stored, target groups may be explored in an interactive manner through application of filter criteria, thereby promoting familiarity with characteristics of the target group. Embodiments allow users who are not modeling experts, to nevertheless interact efficiently with large data volumes to intuitively define and/or explore a target group.

An embodiment of a computer-implemented method comprises providing an engine in communication with a target group comprising a plurality of characteristics, and causing the engine to receive a first input specifying a filter criterion for the target group, the first input resulting from a manipulation of a first target group visualization. Based upon the first input, the engine is caused to communicate a second target group visualization depicting a characteristic included in the filter criterion, the second target group visualization indicating a size of the target group included within the filter criterion.

A non-transitory computer readable storage medium embodies a computer program for performing a method comprising providing an engine in communication with a target group comprising a plurality of characteristics, and causing the engine to receive a first input specifying a filter criterion for the target group, the first input resulting from a manipulation of a first target group visualization. Based upon the first input, the engine is caused to communicate a second target group visualization depicting a characteristic included in the filter criterion, the second target group visualization indicating a size of the target group included within the filter criterion.

An embodiment of a computer system comprises one or more processors and a software program executable on said computer system. The software program is configured to provide an engine in communication with a target group comprising a plurality of characteristics, and to cause the engine to receive a first input specifying a filter criterion for the target group, the first input resulting from a manipulation of a first target group visualization. Based upon the first input, cause the engine to communicate a second target group visualization depicting a characteristic included in the filter criterion, the second target group visualization indicating a size of the target group included within the filter criterion.

In an embodiment the first target group visualization represents a size of the target group as a first circle having a first diameter, and the second target group visualization represents the size of the target group included within the filter criterion, as a second circle inside the first circle and having a second diameter smaller than the first diameter.

According to certain embodiments the second circle has a color different from the first circle.

In some embodiments the first target group visualization represents a size of the target group as a funnel having a first funnel portion with a first width, and the second target group visualization represents the size of the target group included within the filter criterion, as a second funnel portion with a second width smaller than the first width.

In particular embodiments the second target group visualization represents the size of the target group included within the filter criterion as a pie chart, a bar chart, or a curve.

In various embodiments the target group is stored in an in-memory database and the engine comprises a database engine of the in-memory database.

According to some embodiments the second target group visualization comprises a moveable view element.

The following detailed description and accompanying drawings provide a better understanding of the nature and advantages of particular embodiments.

### BRIEF DESCRIPTION OF THE DRAWINGS

FIG. 1 shows a simplified view of a system according to an embodiment.

FIG. 1A is a simplified flow diagram showing target group definition and exploration.

FIG. 2 is a simplified flow diagram showing a method of target group definition according to an embodiment.

FIGS. 3A-3J are screen shots showing various views of a user interface for target group definition according to an embodiment.

FIG. 4 is a simplified flow diagram showing a method of target group definition according to an embodiment.

FIGS. 5A-5G are screen shots showing various views of a user interface for target group exploration according to an embodiment.

FIG. 6 illustrates hardware of a special purpose computing machine configured to perform target group exploration according to an embodiment.

FIG. 7 illustrates an example of a computer system.

### DETAILED DESCRIPTION

Described herein are techniques allowing interactive analysis for target group exploration. The apparatuses, methods, and techniques described below may be implemented as a computer program (software) executing on one or more computers. The computer program may further be stored on a computer readable medium. The computer readable medium may include instructions for performing the processes described below.

In the following description, for purposes of explanation, numerous examples and specific details are set forth in order to provide a thorough understanding. It will be evident, however, to one skilled in the art that embodiments as defined by the claims may include some or all of the features in these examples alone or in combination with other features described below, and may further include modifications and equivalents of the features and concepts described herein.

Embodiments relate to methods and apparatuses creating and analyzing target groups, for example as may be relied upon in conducting marketing campaigns. Certain embodiments allow predictive definition of a target group based upon an underlying complex mathematical model, which may reference large volumes of target data present in a database. An interface affords simplified visualizations of the target group, for example circles of varying diameter representing target group size. Adjustable graphic elements (e.g., sliders) in dashboard views may allow predictive definition of the target group based upon inputs such as marketing cost, target group size, and/or expected revenue, etc. Once defined and stored, target groups may be explored in an interactive manner through application of filter criteria, thereby promoting familiarity with target group characteristics. Embodiments allow users who are not modeling experts, to nevertheless interact efficiently with large data volumes to intuitively define and/or explore a target group.

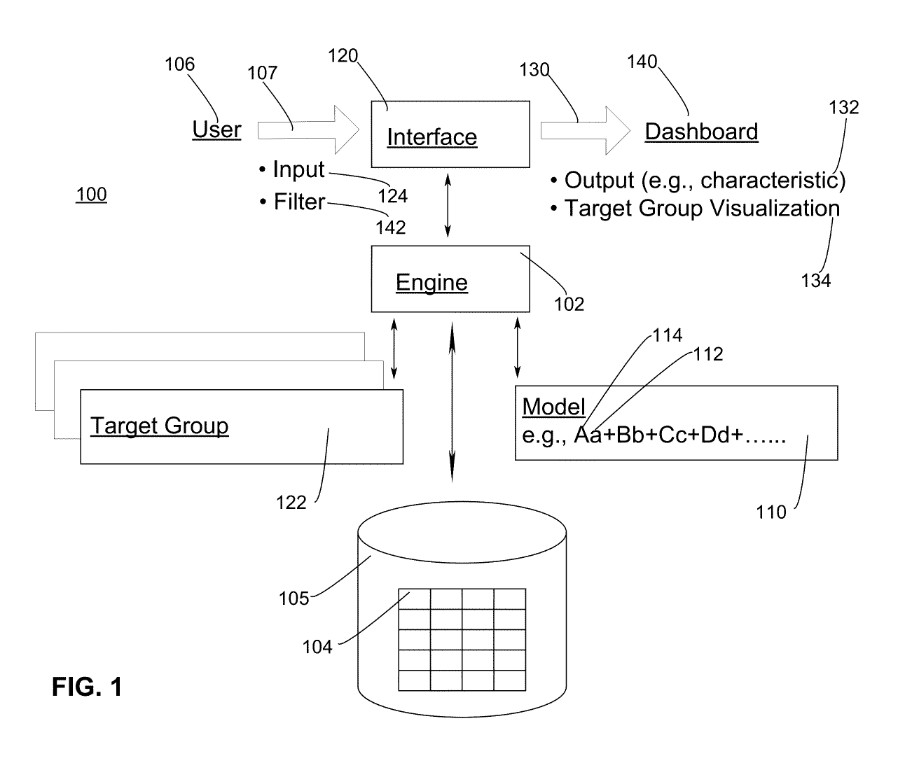

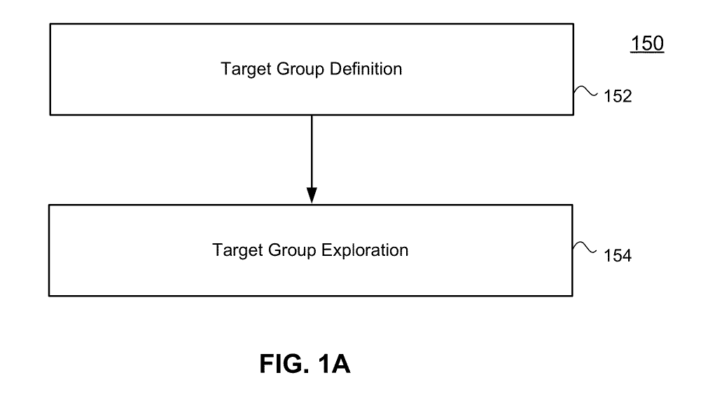

FIG. 1 shows a simplified view of a system according to an embodiment. In particular, system 100 comprises an engine 102 that is in communication with a database 104 stored on a non-transitory computer readable storage medium 105.

The database has stored thereon, data relevant to a target group that is to be defined and/or explored by a user 106. Examples of such data may include but are not limited to:
target name;
target size;
target department;
target contact info;
target industry;
target geographic location;
target financial information;
estimated revenue from target;
relationship to target (e.g., established client or not); and
many other types of available target information.

As described extensively below, embodiments allow a user to define a target group in a predictive manner based upon inputs 107 to an engine 108. Specifically, the engine references a model 110 that establishes a complex relationship between the various characteristics comprising the target group. Here, the model is shown as a linear function of a plurality of characteristics (n) 112, each having a respective corresponding numerical weight/coefficient (N) 114.

It is noted, however, that FIG. 1 represents a simplification for purposes of illustration. In reality, the model will likely be highly complex in nature (e.g., non-linear in structure and comprising many different terms in various combinations).

The model is created by an expert having knowledge in the domain of mathematical modeling. The model thus does not afford an ordinary user with an intuitive sense of the relationship between the various characteristics of a target group as represented by the model.

For example, the model may provide a correlation between a target size and a revenue expected from conducting business with that target. Thus a large member of the target group may be weighted differently in terms of producing expected revenue, than a smaller member of the target group. Similarly, a target group member with whom there is an existing relationship (e.g., an ongoing client or customer), may be weighted differently in terms of producing expected revenue, than a non-client member of the target group offering only the prospect of a possible business opportunity.

Accordingly, in order to afford an ordinary user with an intuitive way of interacting with the model to define a target group in a predictive manner, embodiments provide an interface 120. This interface allows a user to define a target group 122 based upon one or more input characteristics 124 to a model. Examples of such inputs can include but are not limited to:
marketing costs allocated to the target group (including budgetary information);
the size of the target group;
expected revenue from the target group; and
Return On Investment (ROI).

As described at length below, the interface may permit a user to provide inputs directly to a visualization of the target group afforded in a dashboard view. According to some embodiments, such inputs may be provided by adjusting a moveable view element, which can include but is not limited to a slider, a dial, a switch, a scale, a ruler, or some other mechanism.

Based upon inputs received at the interface, the engine references the model to produce corresponding predictive outputs defining the target group and its constituent members. For example, based upon an input regarding a marketing budget allocated to a target group, the model may return to the user via the engine and the interface, outputs comprising the size of the target group and an expected return on investment from that marketing expenditure.

In certain embodiments, the target group model may be in the form of target group characteristics and corresponding numerical coefficients/weights. In such cases, the input may adjust a value of a numerical coefficient/weight corresponding to a particular characteristic, thereby aiding a user to define the target group in a rapid and intuitive manner.

Embodiments may utilize conventional databases storing target data on disk, or may utilize in-memory databases in which target data is stored in RAM. Certain embodiments may leverage the processing power available to in-memory databases, by having the database engine of the database layer function as the engine to define and/or explore the target group.

One example of an in-memory database is the HANA database available from SAP AG of Walldorf, Germany. Other examples of in-memory databases include the SYBASE IQ database also available from SAP AG; the Microsoft Embedded SQL for C (ESQL/C) database available from Microsoft Corp. of Redmond, Wash.; and the Exalytics In-Memory database available from Oracle Corp. of Redwood Shores, Calif.

Importantly, the interface allows the user inputs and corresponding outputs, to be received and produced in a simplified, visual manner. By avoiding having to interact directly with the complex/abstract mathematical structure of the underlying model, a user can be flexible in defining inputs, achieving relatively quickly an intuitive sense of the interrelation between various characteristics of the target group being defined.

FIG. 1 thus shows the interface 120 configured to produce corresponding outputs 130, for example characteristics 132 of the target group (e.g., size, cost, revenue, ROI, member info), as well as a visualization 134 of the defined target group. These outputs may be presented to the user in the form of a dashboard 140. As described in detail below, the dashboard may present target group results for visualization in the form of concentric rings, vertical funnels, tag clouds, pie charts, and any number of a variety of possible display types.

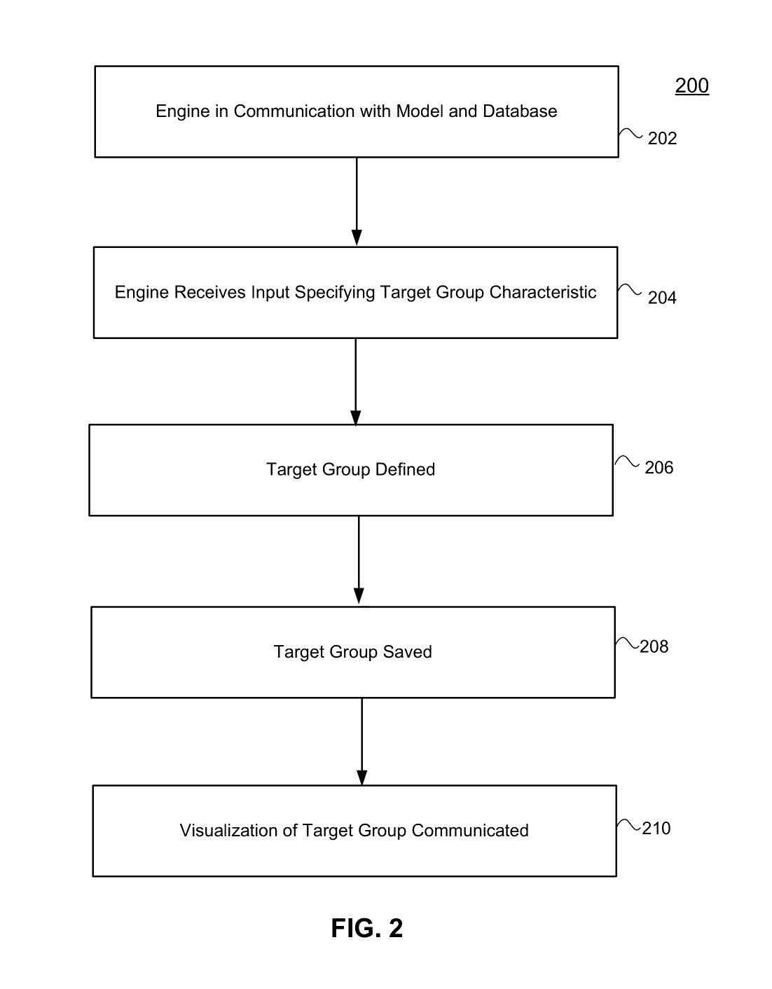

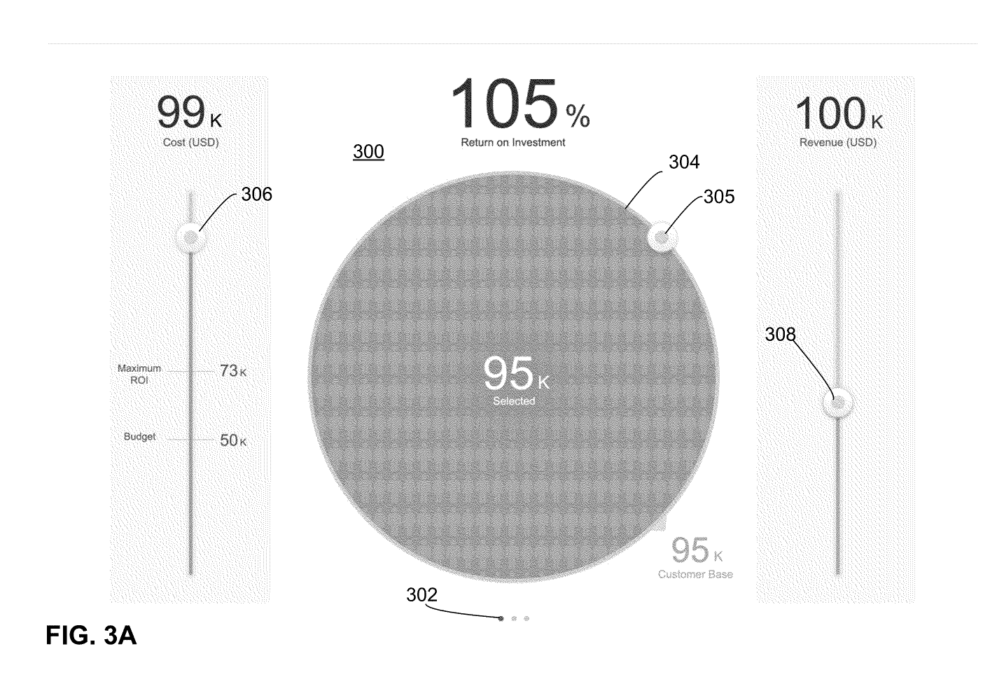

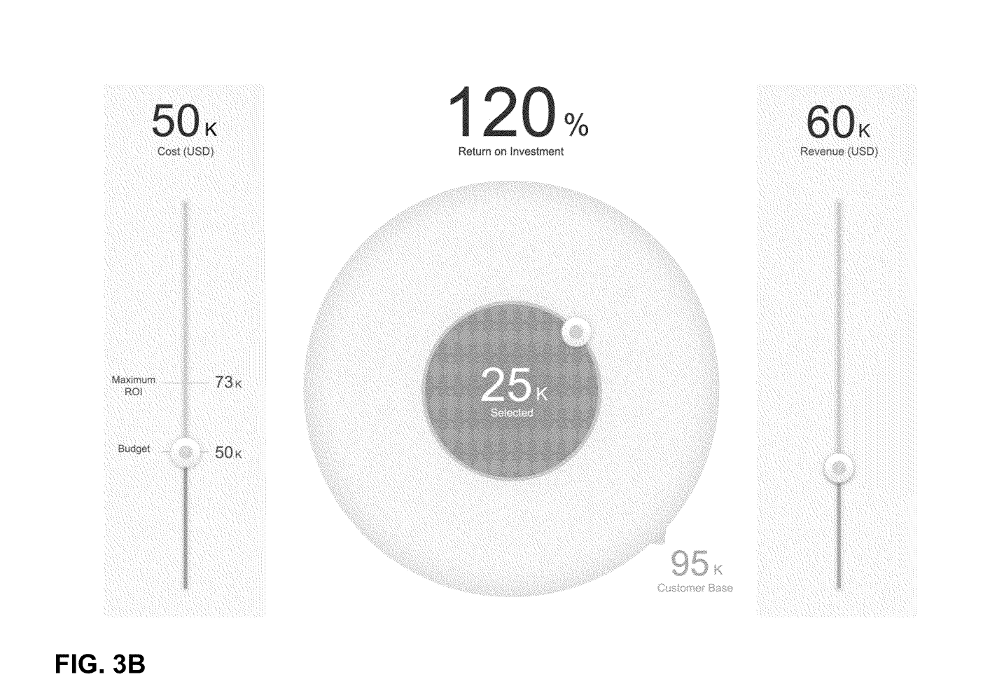

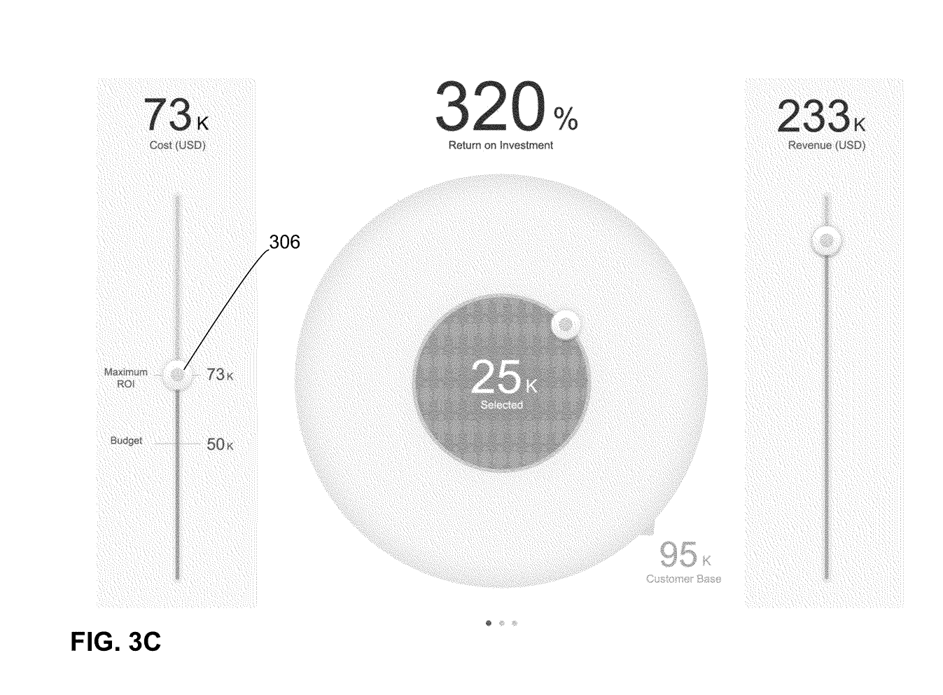

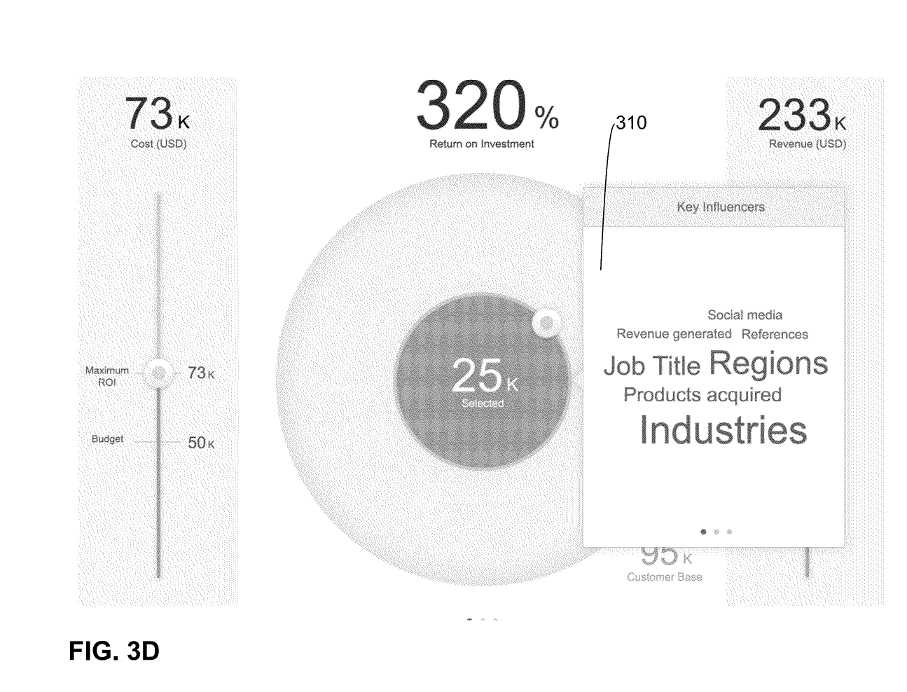

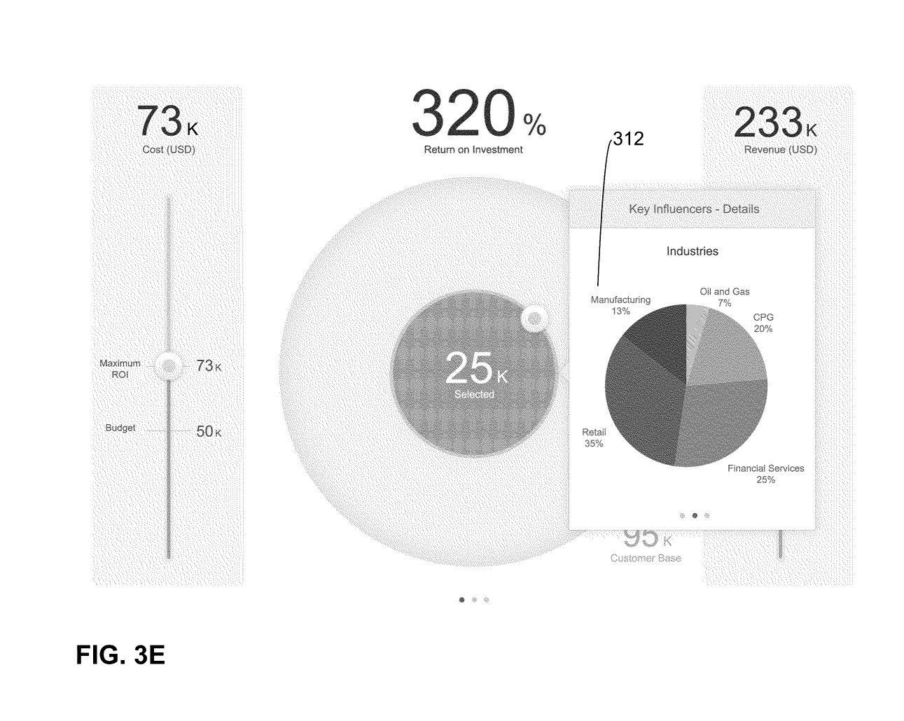

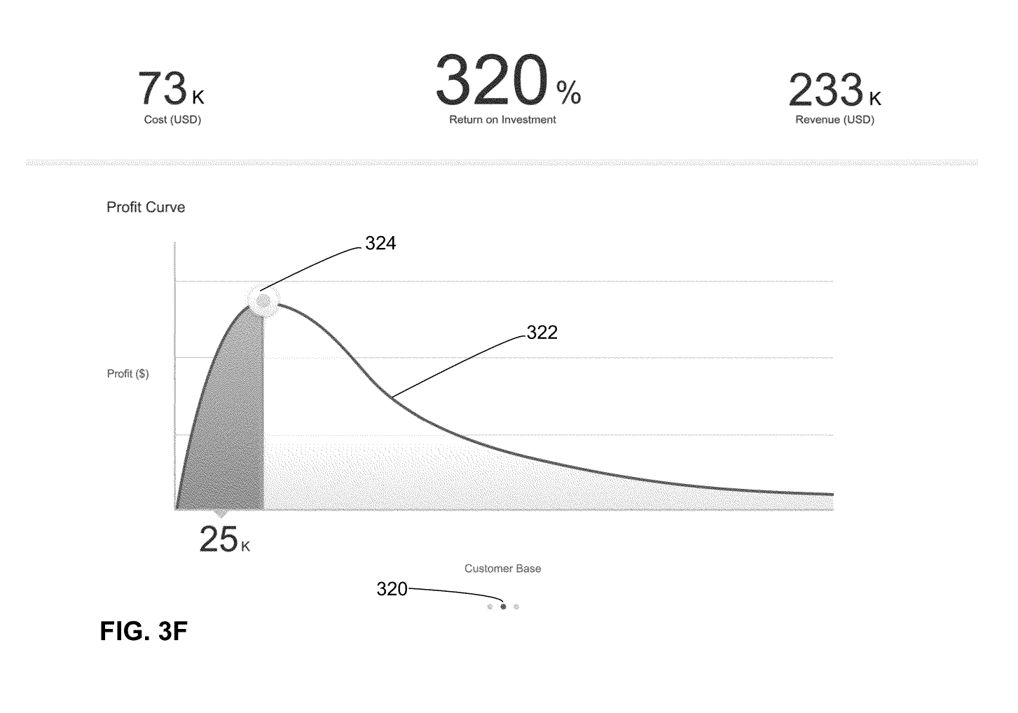

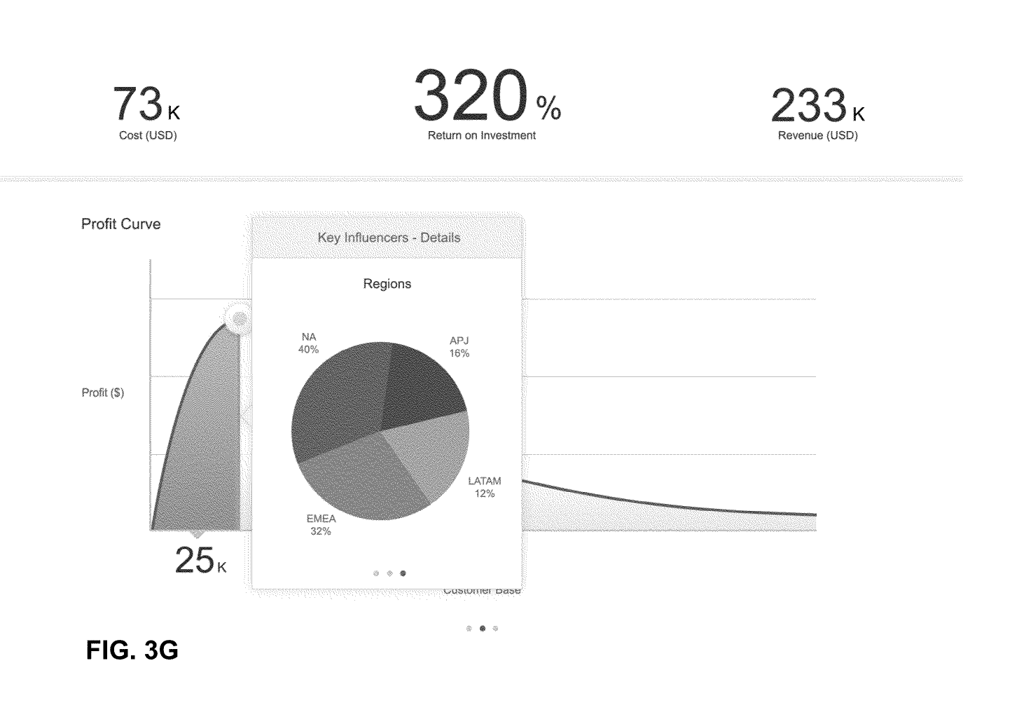

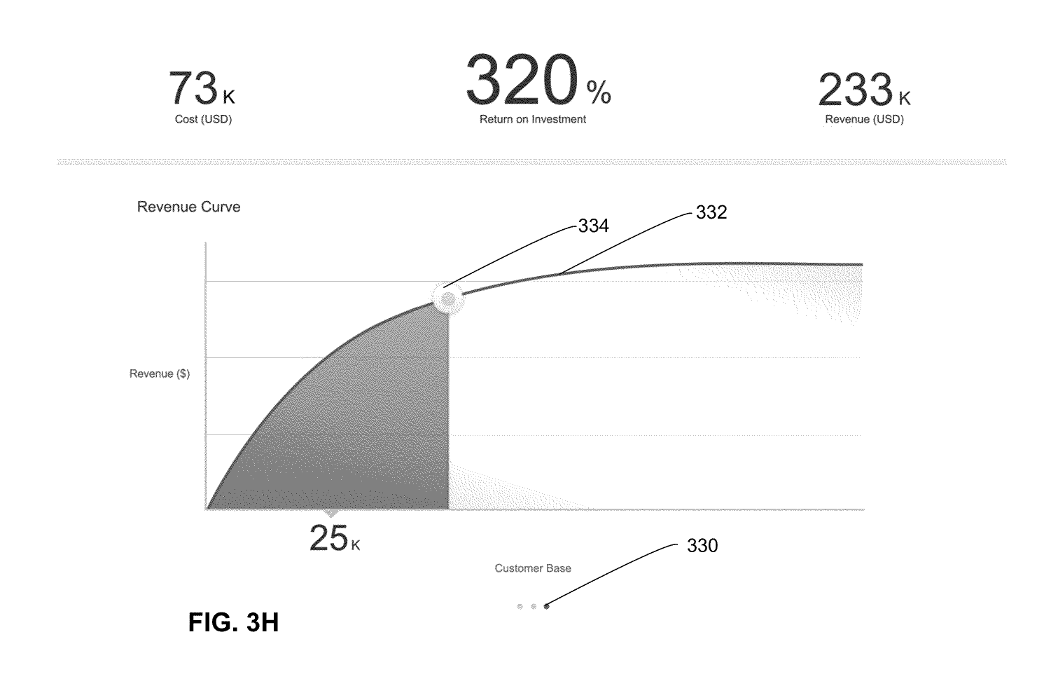

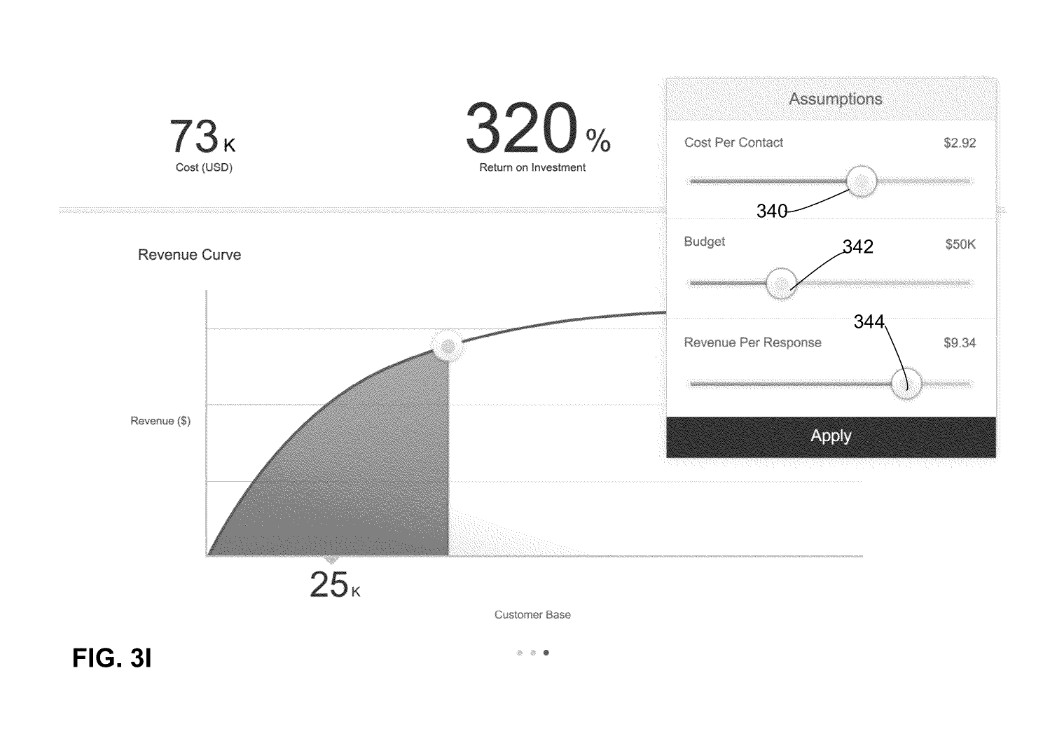

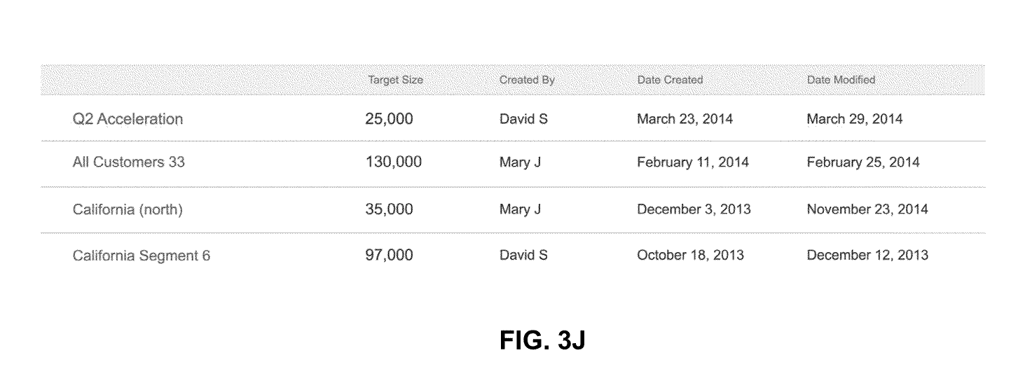

This process of target group definition as outlined above, is summarized as action 152 in the highly simplified process flow 150 of FIG. 1A. Further discussion of target group definition is provided below in the more detailed process flow of FIG. 2, and also in the various exemplary screen shots in FIGS. 3A-3J.

It is noted that the engine 102 of the simplified view shown in FIG. 1, is not limited to referencing a model in order to define a target group and various metrics thereof. The engine may permit exploration of a target group 122 in an interactive manner, by allowing a user to apply inputs in the form of flexible configurable filter criteria 142. Examples of such filter criteria can include restricting a target group by size of its members, by geographic region, by industry, by expected revenue, and/or by a host of any number of other different considerations.

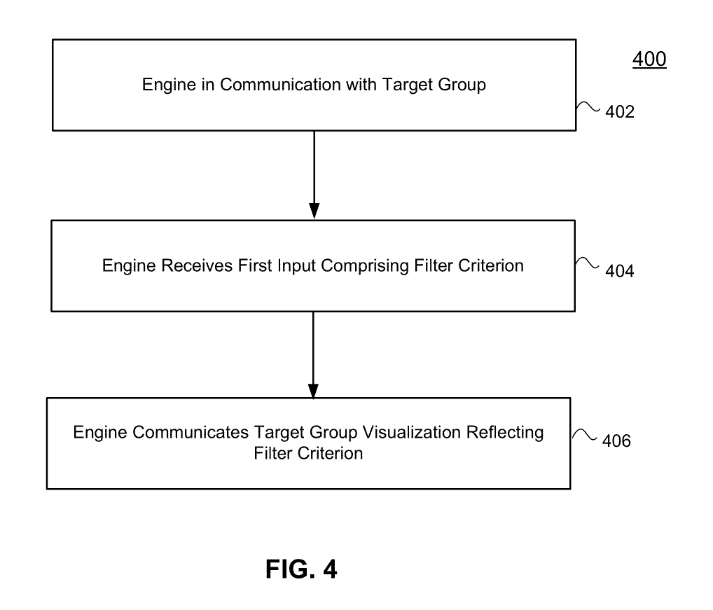

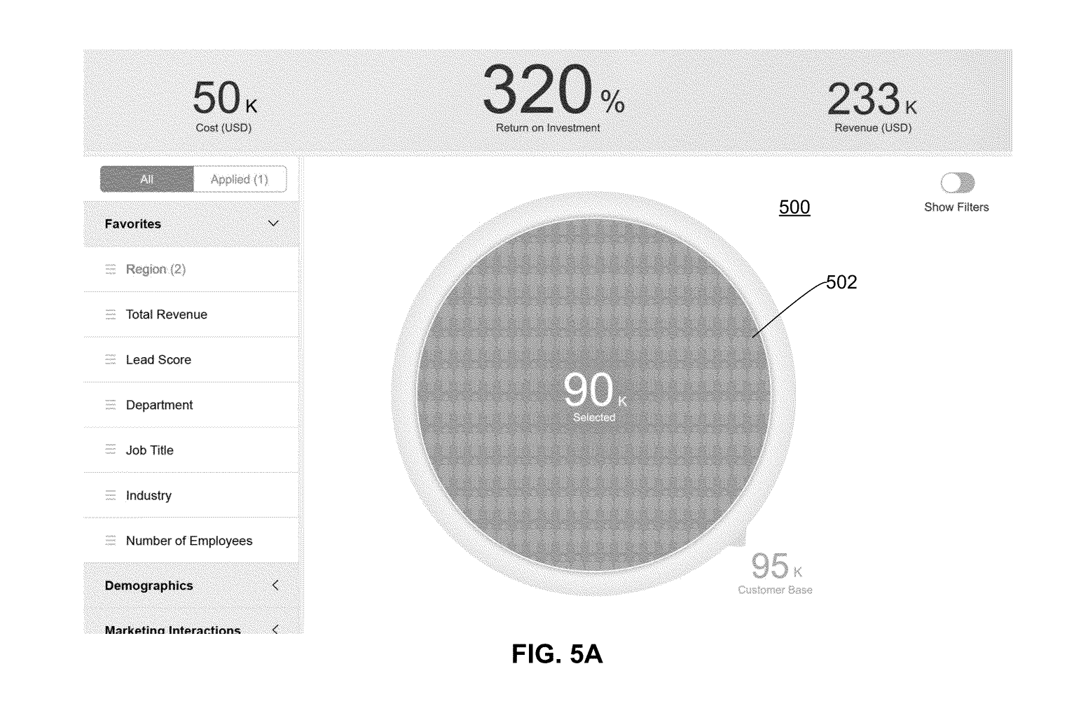

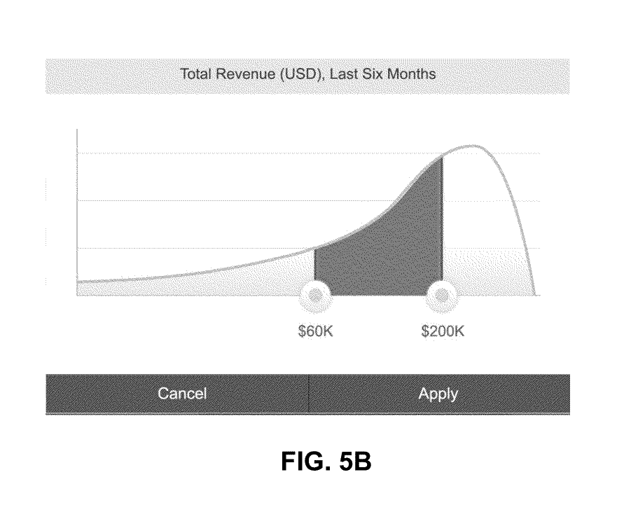

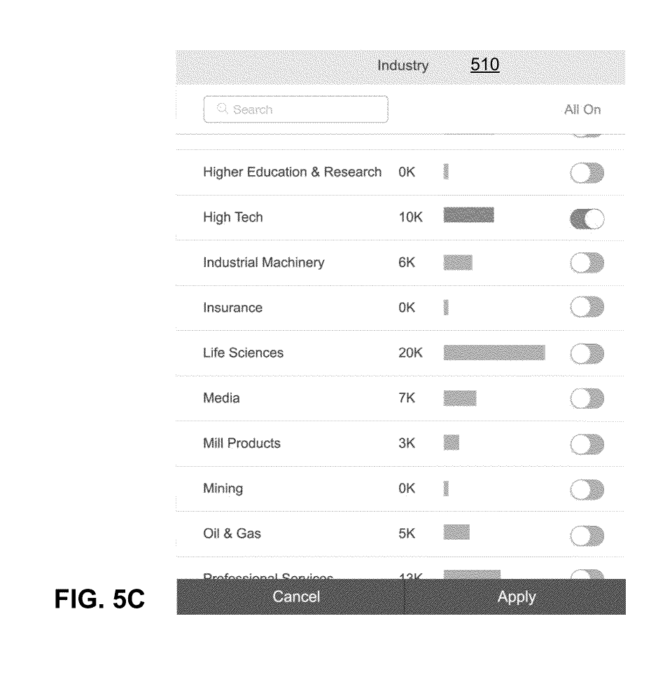

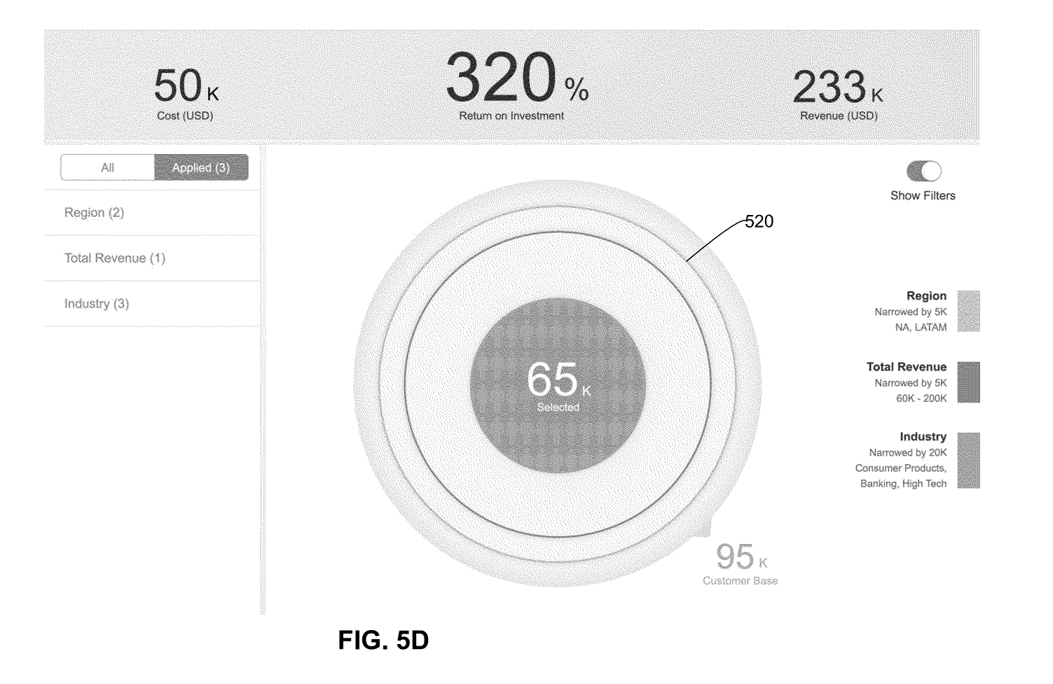

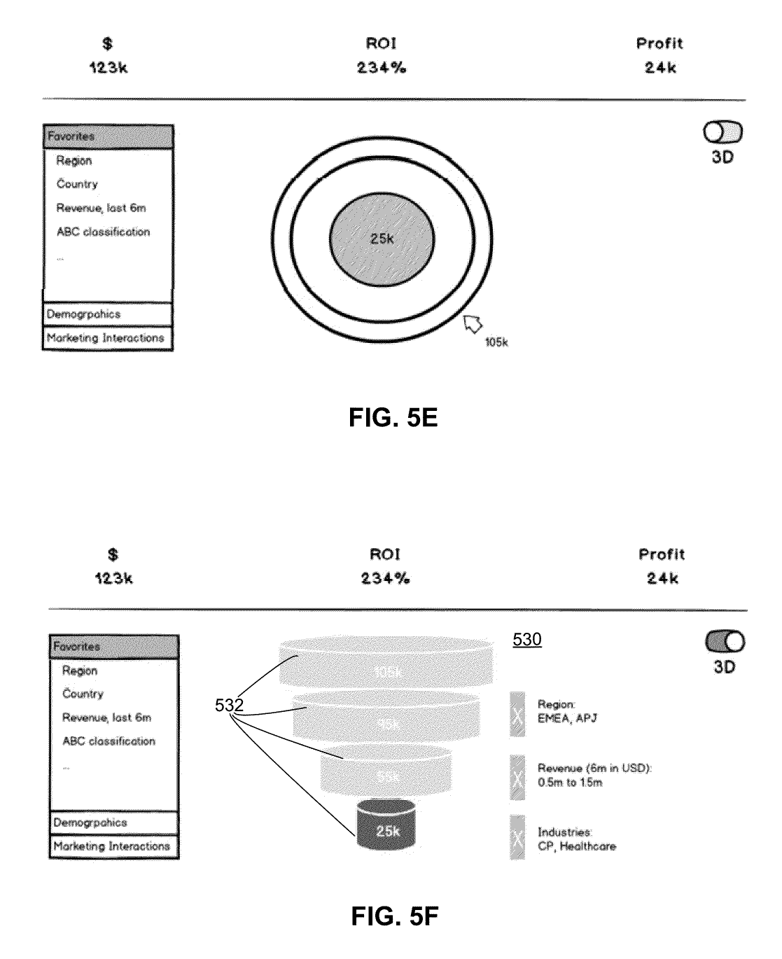

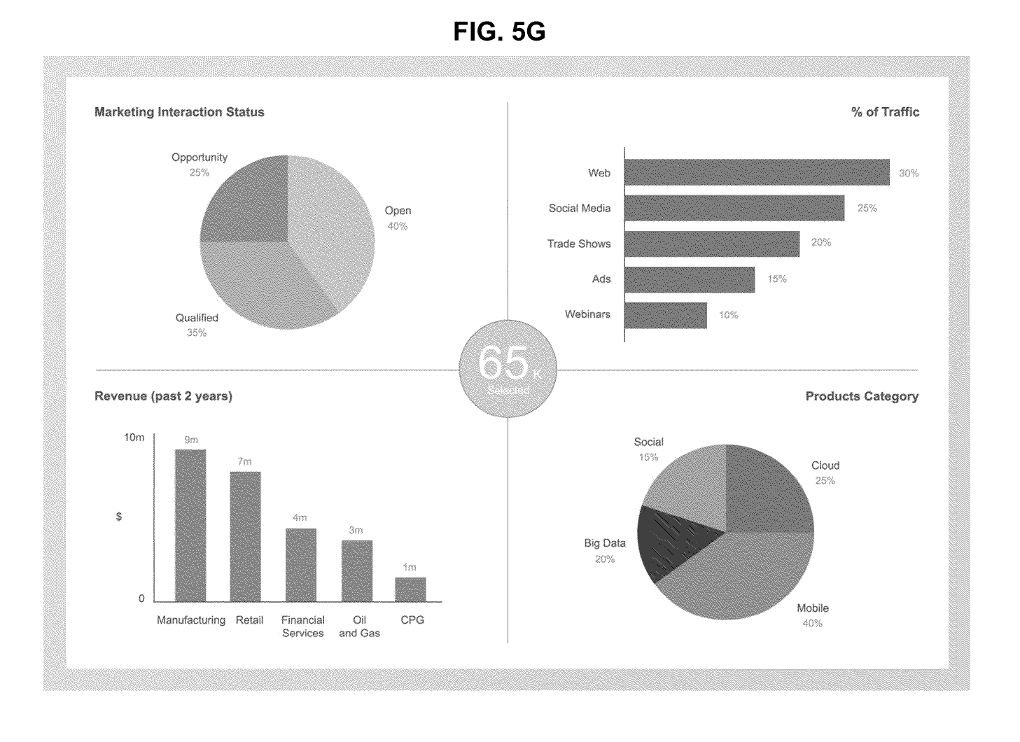

Such a process of interactive target group exploration is summarized as action 154 in the simplified process flow of FIG. 1A. Further discussion of target group exploration is provided later below in the detailed process flow of FIG. 4, and also in the various exemplary screen shots in FIGS. 5A-5G.

Returning now to FIG. 1A, a first action which may be performed is target group definition 152. FIG. 2 provides a more detailed flow diagram illustrating a method 200 of target group definition according to an embodiment.

In a first step 202, an engine is provided in communication with a target group model and with a database comprising target data. In a second step 204 the engine is caused to receive a first input specifying a target group characteristic, the first input resulting from a manipulation of a target group visualization.

In a third step 206, based upon the first input, the engine is caused to reference the target group model and the target data in order to define a target group. In a fourth step 208, the engine is caused to store the target group.

In a fifth step 210, the engine is caused to communicate a modified target group visualization depicting the target group characteristic and a size of the target group.

The target flow definition process flow just described, is now further illustrated by FIGS. 3A-3J. These are screen shots showing various views of a dashboard provided by a user interface for target group definition according to an embodiment.

FIG. 3A shows a circle/slider view 300 that is revealed by tab 302. Here, an initial target group pool comprising a customer base of 95,000 members, is represented by the size of the central circle 304. The edge of this circle includes a slider 305 that allows a user to drag to expand or contract the diameter of the circle, thereby increasing or decreasing the size of the target group.

The left-hand slider 306 allows a user to select a monetary cost of marketing efforts directed to the target group corresponding to this entire customer base. The right-hand slider 308 allows a user to select a revenue expected to be generated from this initial target group pool comprising all existing customers.

Any one of the slider elements 304, 306, and 308 may be manipulated by the user in order to change the inputs to the model that is responsible for defining the target group. For example, FIG. 3B shows the result of dragging the slider 305 to reduce the size of the target group from 95,000 members to only 25,000 members.

As a result of this changed input, FIG. 3B shows the resulting difference in characteristics of the defined target group that are output. That is, the initial target group defined by the entire customer pool, exhibited the following characteristics: size=95,000 members; cost=$99,000; revenue=$100,000; ROI=105%.

By contrast, the narrowed customer group shown in FIG. 3B numbers only 25,000 members, exhibits a reduced cost ($50,000) and revenue ($60,000), but achieves a higher ROI (120%). Such refinement of inputs in defining a target group, may aid a user in achieving optimum benefits from a smaller marketing budget.

FIG. 3C shows the result of making further changes in inputs to the model defining the target group. In particular, FIG. 3C shows that manipulating the slider 306 to increase the marketing cost from a budget of $50,000 to $73,000, results in an increase in expected revenue from $60,000 to $233,000. ROI is thereby increased from 120% to 320%. FIG. 3C thus illustrates how predictive target group definition according to an embodiment, may substantially enhance marketing effectiveness with only a modest increased expense.

FIG. 3D shows that the dashboard provided by the interface, may readily afford a user with additional insight into the target group that is being defined. For example, tapping on the central circle may open a window indicating key influencers on the target group. These key influencers may be visualized in the form of a tag cloud 310, with a size of the key influencers representing their relative importance in defining members of the target group.

FIG. 3E shows another dashboard view affording a user additional insight into details of the key influencers. In particular, selecting the “industry” tag from the cloud in FIG. 3D produces a pie chart 312 breaking down the members of the target group by industry. In this manner, a non-expert user can readily gain an intuitive sense of target group composition for predictive purposes, without requiring detailed knowledge of the structure/operation of the abstract underlying mathematical model.

While FIGS. 3A-3E have afforded a view of a target group in the form of a center circle flanked by sliders, other visualizations are possible. FIG. 3F shows an alternative view of a defined target group in the form of a graph.

In particular, activating the center tab 320 results in display of a profit curve 322 including a slider 324. This profit curve represents the profit (revenue minus marketing cost) that can be achieved over the entire customer base. Manipulation of the slider along the profit curve changes the characteristics of the defined target group (as represented by the shaded area under the curve).

Like the circle/slider view afforded by the first tab, the curve view shown in FIG. 3G allows the user to obtain additional details regarding the defined target group. Here, tapping on the slider opens a window showing a pie chart of the key influencers of the target group, by region.

The interface may afford a non-expert user till other visualizations of a target group being defined. FIG. 3H shows the target group represented by a revenue curve 332 over the entire customer base, accessed by the left hand tab 330. Varying a position of the slider 334 along this revenue curve (analogous to sliding the revenue slider on the right hand side of the circle/slider view), allows the user to change an input to the model defining the target group.

FIG. 3I shows that a user may interact with the interface to open a window allowing still further variation in the model inputs and target group characteristics. Specifically, FIG. 3I shows:
a slider 340 allowing adjustment of a cost per contact input;
a slider 342 allowing adjustment of a budget input; and
a slider 344 allowing adjustment of revenue per response.

Once a user has accessed the model via the engine and interface in order to define a target group deemed valuable, that target group including its members and particular set of characteristics can be stored in the underlying database. FIG. 3J shows saving in the database as “Q2 Acceleration”, the particular target group comprising 25,000 members with a marketing cost of $73,000 to produce a revenue of $233,000.

This “Q2 Acceleration” target group is now available for future reference, as well as revised definition to create a new target group. The “Q2 Acceleration” target group is also available for possible interactive exploration by a non-expert user, as now discussed in detail.

In particular, the second action 154 in the simplified process flow of FIG. 1A is exploration of a target group. Embodiments allow a user to engage interactively with a target group through the application of filters. Such exploration can afford an ordinary user with intuitive insight into the nature and composition of the target group.

With reference to FIG. 1, it is noted that the engine need not reference the model in order to perform the interactive exploration function. Rather, the engine can apply the filters directly to the target group that has been created and stored. In turn, the engine can interact with the interface to produce a visualization to the user regarding that exploration. Such lack of recourse to the underlying model during this target group exploration, reduces processing burden and increases the speed at which target group characteristics may be returned, thereby enhancing the user's experience.

FIG. 4 is a simplified flow diagram showing a method 400 of target group exploration according to an embodiment. In a first step 402, an engine is provided in communication with a target group comprising a plurality of characteristics. This target group may be stored in an underlying database, such as an in-memory database.

In a second step 404, the engine is caused to receive a first input specifying a filter criterion for the target group. This first input may resulting from a manipulation of a first target group visualization (e.g., via a slider).

In a third step 406, based upon the first input the engine is caused to communicate a second target group visualization reflecting a characteristic included in the filter criterion. The second target group visualization may indicate a size of the target group included within the filter criterion. In certain embodiments this may be represented, for example, by an inset circle having a smaller diameter than that of the target group.

The flow diagram of FIG. 4 illustrating target group exploration, is now further described in connection with FIGS. 5A-5G. These are screen shots showing various views of a dashboard provided by a user interface for target group exploration according to an embodiment. FIG. 5A is a dashboard produced by an interface, showing a view that includes a target group 500 having a size indicated by a central circle 502.

The dashboard view of FIG. 5A also shows a window including a plurality of filter criteria. By selecting a filter criterion for “Region”, FIG. 5A shows that the initial target group comprising the entire customer base numbering 95,000 members, is restricted in size to 90,000 members. Assuming the same total revenue figure of $233,000 and ROI of 320% of the “Q2 Acceleration” target group previously defined, the marketing cost may be reduced from $73,000 to $50,000.

FIG. 5B shows that other filters allowing further exploration of the nature of the target group may be applied in an iterative manner. In particular, FIG. 5B shows the target group illustrated by a curve of total revenue over a preceding six month period. Sliders along the curve allow honing in on the sources of the greatest revenue (e.g., between $60,000 and $200,000). This affords a user valuable insight into details of the nature of the target group.

FIG. 5C shows a window that may be opened to afford further user control over filters being applied to explore a target group. In particular, this figure shows details of an additional “Industry” criterion 510 that is applied to filter the current target group.

In particular, FIG. 5D shows that further application of the “High Tech” industry filter further reduces the target group to 65,000 members. Thus without possessing detailed technical knowledge of the mathematical basis for the target group, and without incurring the processing burden/delay of accessing the underlying model, a non-expert user can quickly discern how much of a customer base comprising tens of thousands of members, lies:
in a particular region,
within a particular revenue band, and
in a particular set of industries.
   Such rapid interactive exploration can quickly afford a user with an intuitive grasp over the detailed character of a target group.

FIG. 5D further shows that the impact of applying successive filters upon the target group, may be visualized utilizing techniques such as color and spacing. That is, reduction in size of the initial target group by application of the region filter, may be represented by an inset circumscribed circle 520 having a circumference of a different color (or perhaps line weight or dashing). The successive impact of applying total revenue and industry filter criteria to the target group, may similarly be afforded through use of different colors and/or shapes as indicated in FIG. 5D.

Moreover, visualization of the target group and the impact of filters applied thereto, is not limited to the circle shown in the specific view of FIG. 5D.

In particular, FIG. 5E again shows a simplified representation of a (slightly different) target group as a circle. However, the dashboard view of FIG. 5F depicts that same target group in the form of a vertical funnel 530 comprising individual layers 532 representing the result of interactive application of filters. In certain embodiments, conversion between the different target group dashboard views represented of FIGS. 5E and 5F, may be accomplished by a user dragging a finger in a vertical direction along the screen.

Returning to the specific target group shown in the dashboard view of FIG. 5D, the engine may afford the user via the interface, additional views regarding characteristics of a target group that is being explored. In particular, FIG. 5G shows a dashboard view of the target group broken down by different characteristics such as:
marketing interaction status,
% of traffic,
revenue over time
products category.

Moreover, these characteristics of the target group may be presented to the user in the form of different visualizations. Here, the visualizations include a horizontal bar chart, a vertical bar chart, and a pie chart. Other visualizations are possible, including but not limited to plots, graphs, tables, trees, tag clouds, and others.

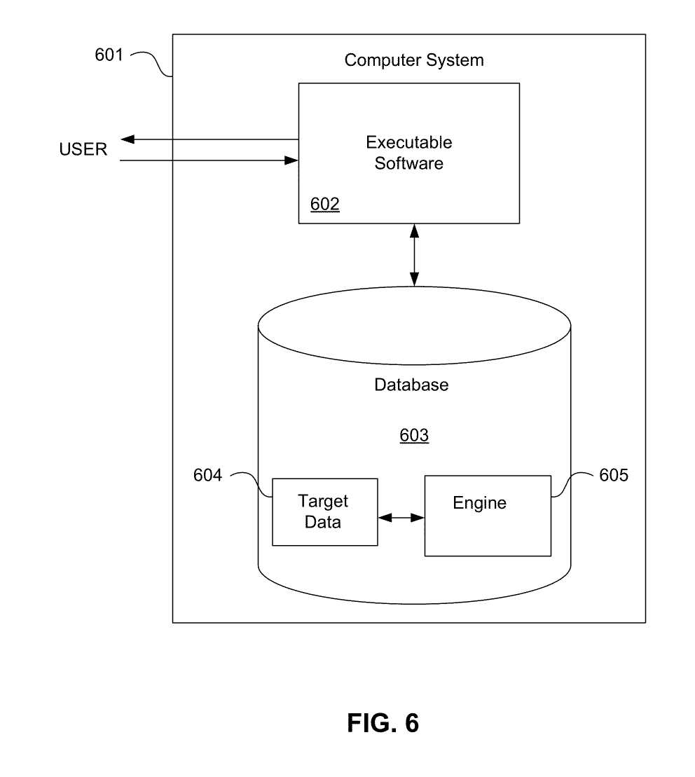

FIG. 6 illustrates hardware of a special purpose computing machine configured to perform target group definition and/or exploration according to an embodiment. In particular, computer system 601 comprises a processor 602 that is in electronic communication with a non-transitory computer-readable storage medium 603. This computer-readable storage medium has stored thereon code 605 corresponding to an engine. Code 604 corresponds to target data. Code may be configured to reference data stored in a database of a non-transitory computer-readable storage medium, for example as may be present locally or in a remote database server. Software servers together may form a cluster or logical network of computer systems programmed with software programs that communicate with each other and work together in order to process requests.

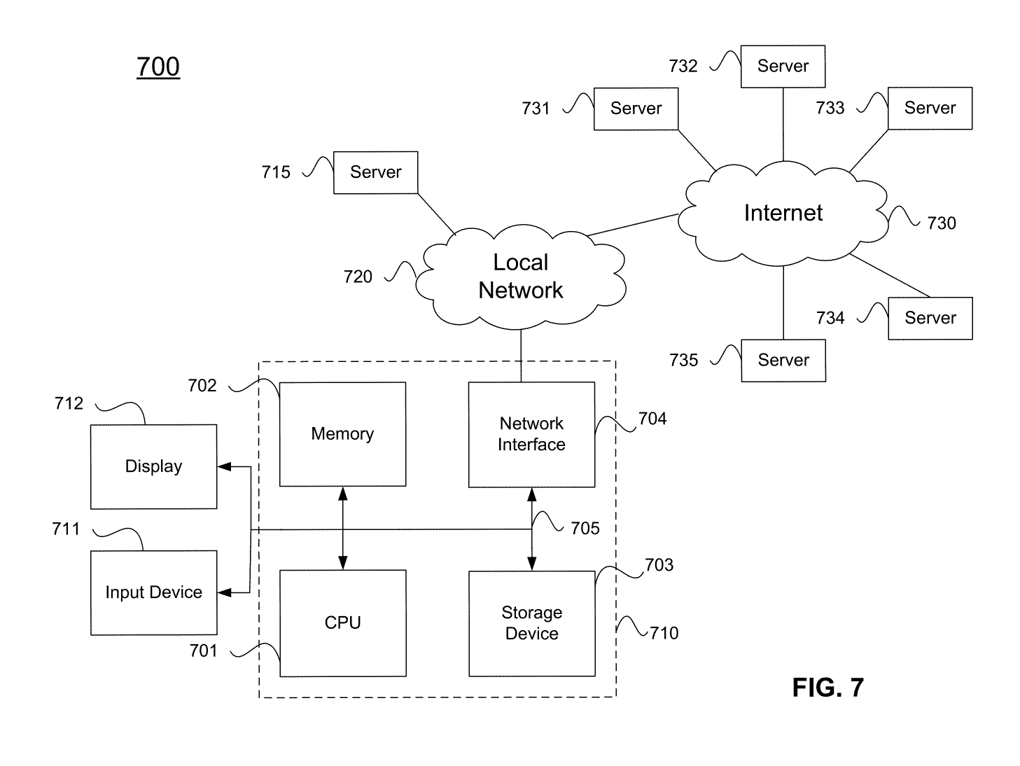

An example computer system 710 is illustrated in FIG. 7. Computer system 710 includes a bus 705 or other communication mechanism for communicating information, and a processor 701 coupled with bus 705 for processing information. Computer system 710 also includes a memory 702 coupled to bus 705 for storing information and instructions to be executed by processor 701, including information and instructions for performing the techniques described above, for example. This memory may also be used for storing variables or other intermediate information during execution of instructions to be executed by processor 701. Possible implementations of this memory may be, but are not limited to, random access memory (RAM), read only memory (ROM), or both. A storage device 703 is also provided for storing information and instructions. Common forms of storage devices include, for example, a hard drive, a magnetic disk, an optical disk, a CD-ROM, a DVD, a flash memory, a USB memory card, or any other medium from which a computer can read. Storage device 703 may include source code, binary code, or software files for performing the techniques above, for example. Storage device and memory are both examples of computer readable mediums.

Computer system 710 may be coupled via bus 705 to a display 712, such as a cathode ray tube (CRT) or liquid crystal display (LCD), for displaying information to a computer user. An input device 711 such as a keyboard and/or mouse is coupled to bus 705 for communicating information and command selections from the user to processor 701. The combination of these components allows the user to communicate with the system. In some systems, bus 705 may be divided into multiple specialized buses.

Computer system 710 also includes a network interface 704 coupled with bus 705. Network interface 704 may provide two-way data communication between computer system 710 and the local network 720. The network interface 704 may be a digital subscriber line (DSL) or a modem to provide data communication connection over a telephone line, for example. Another example of the network interface is a local area network (LAN) card to provide a data communication connection to a compatible LAN. Wireless links are another example. In any such implementation, network interface 704 sends and receives electrical, electromagnetic, or optical signals that carry digital data streams representing various types of information.

Computer system 710 can send and receive information, including messages or other interface actions, through the network interface 704 across a local network 720, an Intranet, or the Internet 730. For a local network, computer system 710 may communicate with a plurality of other computer machines, such as server 715. Accordingly, computer system 710 and server computer systems represented by server 715 may form a cloud computing network, which may be programmed with processes described herein. In the Internet example, software components or services may reside on multiple different computer systems 710 or servers 731-735 across the network. The processes described above may be implemented on one or more servers, for example. A server 731 may transmit actions or messages from one component, through Internet 730, local network 720, and network interface 704 to a component on computer system 710. The software components and processes described above may be implemented on any computer system and send and/or receive information across a network, for example.

The above description illustrates various embodiments of the present invention along with examples of how aspects of the present invention may be implemented. The above examples and embodiments should not be deemed to be the only embodiments, and are presented to illustrate the flexibility and advantages of the present invention as defined by the following claims. Based on the above disclosure and the following claims, other arrangements, embodiments, implementations and equivalents will be evident to those skilled in the art and may be employed without departing from the spirit and scope of the invention as defined by the claims.

What is claimed is:

1. A computer-implemented method comprising:
providing an engine in communication with a target group comprising a plurality of characteristics;
causing the engine to receive a first input specifying a filter criterion for the target group, the first input resulting from a manipulation of a first target group visualization; and
based upon the first input, causing the engine to communicate a second target group visualization depicting a characteristic included in the filter criterion, the second target group visualization indicating a size of the target group included within the filter criterion.

2. A method as in claim 1 wherein:
the first target group visualization represents a size of the target group as a first circle having a first diameter; and
the second target group visualization represents the size of the target group included within the filter criterion, as a second circle inside the first circle and having a second diameter smaller than the first diameter.

3. A method as in claim 2 wherein the second circle has a color different from the first circle.

4. A method as in claim 1 wherein:
the first target group visualization represents a size of the target group as a funnel having a first funnel portion with a first width; and
the second target group visualization represents the size of the target group included within the filter criterion, as a second funnel portion with a second width smaller than the first width.

5. A method as in claim 1 wherein the second target group visualization represents the size of the target group included within the filter criterion as a pie chart, a bar chart, or a curve.

6. A method as in claim 1 wherein:
the target group is stored in an in-memory database; and
the engine comprises a database engine of the in-memory database.

7. A method as in claim 1 wherein the second target group visualization comprises a moveable view element.

8. A non-transitory computer readable storage medium embodying a computer program for performing a method, said method comprising:
providing an engine in communication with a target group comprising a plurality of characteristics;
causing the engine to receive a first input specifying a filter criterion for the target group, the first input resulting from a manipulation of a first target group visualization; and
based upon the first input, causing the engine to communicate a second target group visualization depicting a characteristic included in the filter criterion, the second target group visualization indicating a size of the target group included within the filter criterion.

9. A non-transitory computer readable storage medium as in claim 8 wherein:
the first target group visualization represents a size of the target group as a first circle having a first diameter; and
the second target group visualization represents the size of the target group included within the filter criterion, as a second circle inside the first circle and having a second diameter smaller than the first diameter.

10. A non-transitory computer readable storage medium as in claim 9 wherein the second circle has a color different from the first circle.

11. A non-transitory computer readable storage medium as in claim 8 wherein:
the first target group visualization represents a size of the target group as a funnel having a first funnel portion with a first width; and
the second target group visualization represents the size of the target group included within the filter criterion, as a second funnel portion with a second width smaller than the first width.

12. A non-transitory computer readable storage medium as in claim 8 wherein the second target group visualization represents the size of the target group included within the filter criterion as a pie chart, a bar chart, or a curve.

13. A non-transitory computer readable storage medium as in claim 8 wherein:
the target group is stored in an in-memory database; and
the engine comprises a database engine of the in-memory database.

14. A non-transitory computer readable storage medium as in claim 8 wherein the second target group visualization comprises a moveable view element.

15. A computer system comprising:
one or more processors;
a software program, executable on said computer system, the software program configured to:
provide an engine in communication with a target group comprising a plurality of characteristics;
cause the engine to receive a first input specifying a filter criterion for the target group, the first input resulting from a manipulation of a first target group visualization; and
based upon the first input, cause the engine to communicate a second target group visualization depicting a characteristic included in the filter criterion, the second target group visualization indicating a size of the target group included within the filter criterion.

16. A computer system as in claim 15 wherein:
the first target group visualization represents a size of the target group as a first circle having a first diameter; and
the second target group visualization represents the size of the target group included within the filter criterion, as a second circle inside the first circle and having a second diameter smaller than the first diameter.

17. A computer system as in claim 16 wherein the second circle has a color different from the first circle.

18. A computer system as in claim 15 wherein:
the first target group visualization represents a size of the target group as a funnel having a first funnel portion with a first width; and
the second target group visualization represents the size of the target group included within the filter criterion, as a second funnel portion with a second width smaller than the first width.

19. A computer system as in claim 15 wherein the second target group visualization represents the size of the target group included within the filter criterion as a pie chart, a bar chart, or a curve.

20. A computer system as in claim 15 wherein:
the target group is stored in an in-memory database; and
the engine comprises a database engine of the in-memory database.
